(19) United States
(12) Patent Application Publication
(10) Pub. No.: US 2019/0178202 A1
(43) Pub. Date: Jun. 13, 2019

(54) Piston Consisting Of An Inner Part And An Outer Part

(71) Applicant: KS Kolbenschmidt GmbH, Neckarsulm (DE)

(72) Inventor: Gregor Müller, Mannheim (DE)

(21) Appl. No.: 16/321,855

(22) PCT Filed: Aug. 30, 2017
(86) PCT No.: PCT/EP2017/071737

§ 371 Date: Jan. 30, 2019

(30) Foreign Application Priority Data
Sep. 2, 2016 (DE) 10 2016 116 474.7

(51) Int. Cl. F02F 3/00; F02F 3/22

(52) U.S. Cl. CPC F02F 3/003; F02F 2003/0061; F02F 3/22

(57) ABSTRACT

A piston for an internal combustion engine including an outer part and an inner part. The outer part includes a ring groove region and a piston skirt. The inner part includes a piston boss and pin bores. The inner part is inserted into the outer part and engages the outer part at a joint in at least one vertically-oriented plane. The inner part and the outer part are non-detachably joined at the joint forming a one-piece piston.

### FIELD OF INVENTION

The invention relates to a piston of an internal combustion engine and to a method for producing a piston of this kind in accordance with the features of the respective preambles of the two independent patent claims.

The invention relates to a novel design for a piston of an internal combustion engine.

### BACKGROUND

Pistons for internal combustion engines are produced in one piece, e.g. by casting. Moreover, there is a known practice of producing ready-to-use one-piece pistons by manufacturing a top part and a bottom part and joining them non-detachably in a horizontal plane.

A piston which has a ring groove region, a piston skirt and a piston boss for receiving a piston pin, wherein the piston is formed by two parts, which are produced separately from each other and are joined together non-detachably to form the one-piece piston, is known from DE 10 2016 116 046 A1.

The plane in which the top part and the bottom part are joined together non-detachably is horizontal, i.e. transverse with respect to a piston stroke axis of the piston.

### SUMMARY

It is the underlying object of the invention to specify a novel design for a piston of an internal combustion engine and a corresponding production method.

In respect of the piston, it is envisaged according to the invention that the piston is formed by an outer part, which includes the ring groove region and the piston skirt and into which is inserted (more particularly concentrically with respect to the piston stroke axis) an inner part, which includes the piston bosses and the pin bores, wherein the two parts are joined together non-detachably in at least one vertical plane. By virtue of the vertical alignment of the joining plane, the stresses acting on the piston, in particular tensile and compression forces during combustion, can be absorbed and transmitted significantly better than is the case with a horizontal joining plane. Moreover, greater geometrical degrees of freedom are available in the configuration of the two parts since large areas of the two parts, which have to be produced or machined, are significantly more accessible than in the case of two parts which are produced separately from each other and are joined in a horizontal plane. The two mutually opposite piston bosses with their respective pin bores are thus at least partially, in particular completely, surrounded by the piston skirt of the outer part. In this case, the piston skirt has an aperture, preferably two opposite apertures, via which the piston pin can be inserted into the pin bores in order thereby to connect the piston rod to the piston. Instead of a very largely or completely cylindrical piston skirt (with at least one aperture for installing the piston pin), it is also possible to consider loadbearing skirt wall sections which extend from an upper region of the outer part to the lower end thereof (which can simultaneously also be the lower end of the piston).

The two parts can consist of the same material or of different materials. The same applies to the production methods for these. The two parts can likewise be of symmetrical design with respect to the piston axis, but do not have to be.

In a special embodiment, the two ends of the two parts (outer and inner part) forming the piston extend from the upper end of the piston (which faces the combustion chamber), to the lower end thereof (which faces the crankcase). The outer part is not designed as a ring element known per se, which is arranged and secured around the inner part only in the upper region of the piston (above an oil scraper ring or above the ring groove region per se).

As a development of the invention, provision is made in principle for the piston to have a cooling duct, wherein, in this case, the alternatives envisaged are either that the cooling duct is formed exclusively by the inner part, that the cooling duct is formed exclusively by the outer part or that the inner and the outer part are configured in such a way that the cooling duct is formed after they are joined together. In the last-mentioned case, this means that both the inner and the outer part contribute to the formation of the cooling duct, to be more precise the walls thereof.

As a development of the invention, it is envisaged that at least one joint, preferably an encircling joint, between the two parts is formed by these two parts and has mutually corresponding geometries, wherein the geometries are chosen so that, when the inner part is inserted into the outer part, positive engagement arises in the region of the joint. There is no need for a further joining operation, e.g. welding or brazing or the like, since the two parts are connected positively to one another by a suitable joining method. However, a materially integral joining method can optionally be performed in addition.

In respect of the method for producing a piston, it is envisaged according to the invention that the piston is formed by an outer part, which includes the ring groove region and the piston skirt and into which is inserted (more particularly concentrically with respect to the piston stroke axis) an inner part, which includes the piston bosses and the pin bores, wherein the two parts are then joined together non-detachably in a vertical plane.

Thus, according to the invention, a novel alignment of the at least one joining plane and the configuration of the two parts which form the finished piston after being joined together is available, in which the same advantages apply as have already been described above with respect to the piston itself.

Given this situation, the underlying concept of the invention is no longer to form the at least one parting plane horizontally but to form it substantially vertically.

An outer, approximately cylindrical part is produced, into which an inner part is inserted (more particularly concentrically with respect to the piston stroke axis), fixed in its position and connected non-detachably to the outer part.

The outer, approximately cylindrical part has essential piston elements, such as a ring groove region, a piston skirt and the like.

The inner part likewise has essential elements of the piston, e.g. a combustion chamber recess but especially the piston bosses with the pin bore situated therein.

In the upper region of the two parts, which is associated with the combustion chamber of the internal combustion engine, said parts can have geometries which form an encircling annular cooling duct, either in isolation or, as an alternative, together after joining. The geometries in the outer and/or inner part which form the cooling duct are freely accessible for machining, and therefore any shapes, even relatively complex ones, can be implemented for the cooling duct.

Many different possibilities are available for joining the inner part non-detachably to the outer part. Any nonpositive and/or positive as well as any materially integral joining method may be considered.

### BRIEF DESCRIPTION OF THE DRAWINGS

FIG. 1 is a cross-sectional view of one example of a piston of the present invention.

FIG. 2 is an alternate cross-sectional view of the piston shown in FIG. 1.

FIG. 3 is a perspective view of an example of a piston outer part of the present invention.

FIG. 4 is a perspective view of an example of a piston inner part of the present invention.

FIGS. 5-10 are partial cross-sectional views of alternate configurations in the region of a joint between exemplary piston inner parts and outer parts.

### DETAILED DESCRIPTION

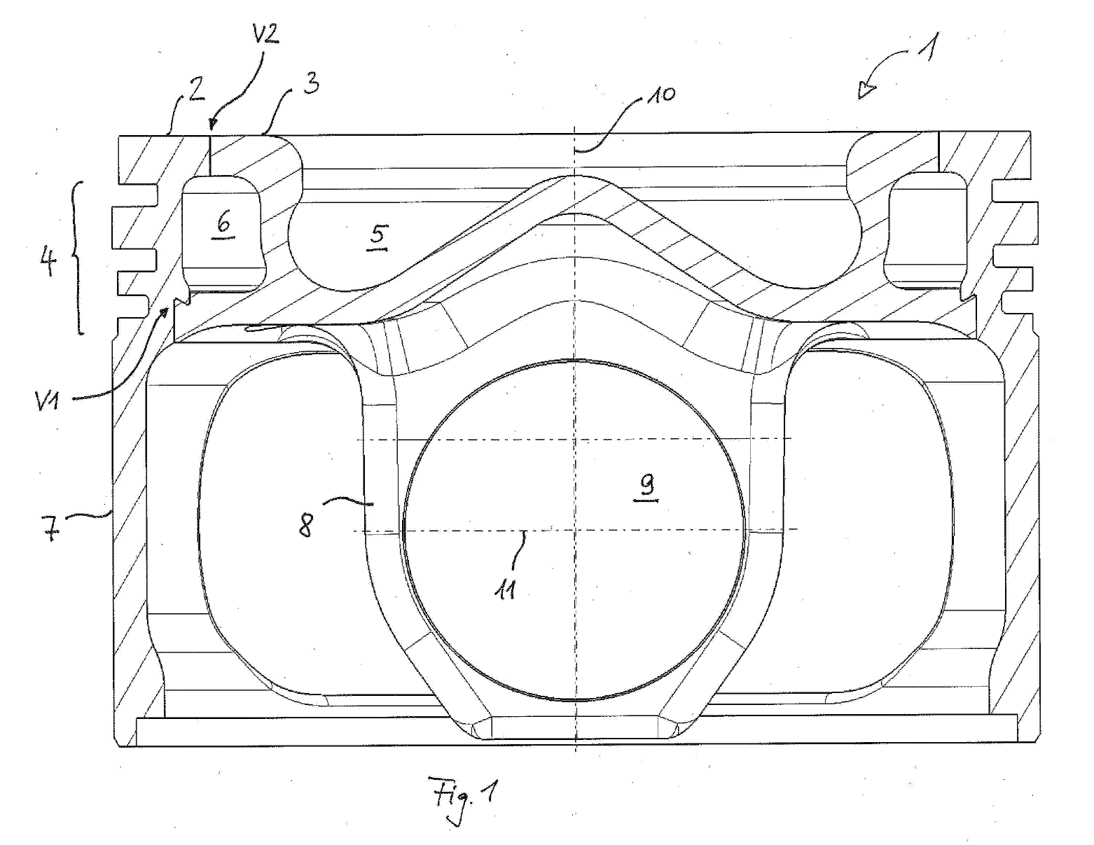

An illustrative embodiment of a piston 1 according to the invention is illustrated in FIGS. 1 and 2 in two different views. This piston 1 has an outer, substantially cylindrical outer part 2, into which an inner part 3 is inserted and moved into the desired position thereof in relation to the outer part 2.

After the insertion of the inner part 3 into the outer part 2, the two parts 2, 3 are connected to each other at at least one joint, ensuring that relative movement between these two parts 2, 3 is no longer possible. It is conceivable to have just one joint, preferably an encircling joint. In a particularly advantageous way, the two parts 2, 3 are connected to each other by two joints V1, V2, which are preferably both of encircling configuration and which are situated in different planes. Moreover, the alignment of the at least one joint V1, V2 is no longer horizontal but vertical. The manner in which the two parts 2, 3 are connected to each other at the joints V1, V2 can be the same or, as an alternative, can be different.

Otherwise, the two parts 2, 3 are configured in such a way that they form conventional piston elements such as a ring groove region 4, a combustion chamber recess 5, a cooling duct 6, a piston skirt 7, piston bosses 8 with pin bores 9 and, if appropriate, further piston elements.

10 denotes a piston stroke axis and 11 denotes a pin axis.

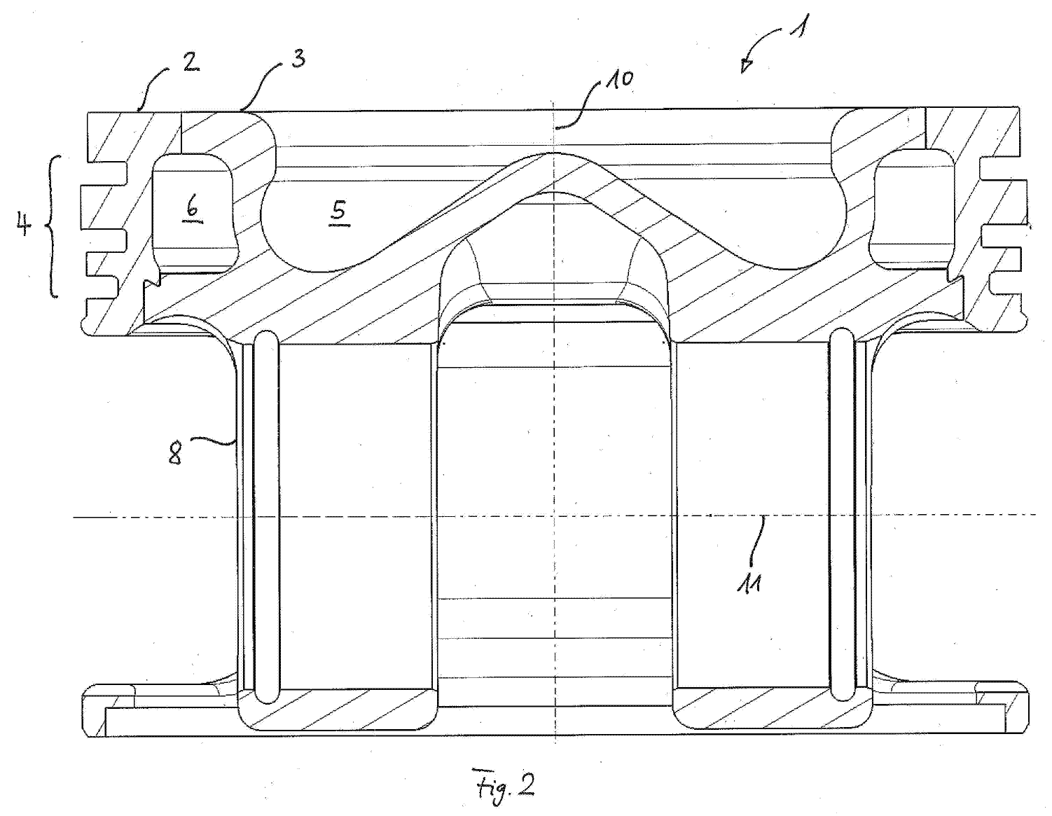

In FIGS. 3 and 4, the two parts 2, 3 are illustrated once again in isolation before being inserted one into the other. FIG. 3 shows the outer part 2, wherein it can be seen that said part is formed substantially in a cylinder shape. It is preferably cast or forged, although other production methods are not excluded.

FIG. 4 shows the inner part 3, which can likewise be obtained in any suitable production method, e.g. casting, forging or the like.

When considering FIGS. 3 and 4, it should be noted that gaps or through bores 7A are formed in the outer part 2 in those regions in which the piston bosses 8 with the pin bores 9 thereof are located in the inner part 3 in order to allow access for the installation of the pin in the pin bores 9.

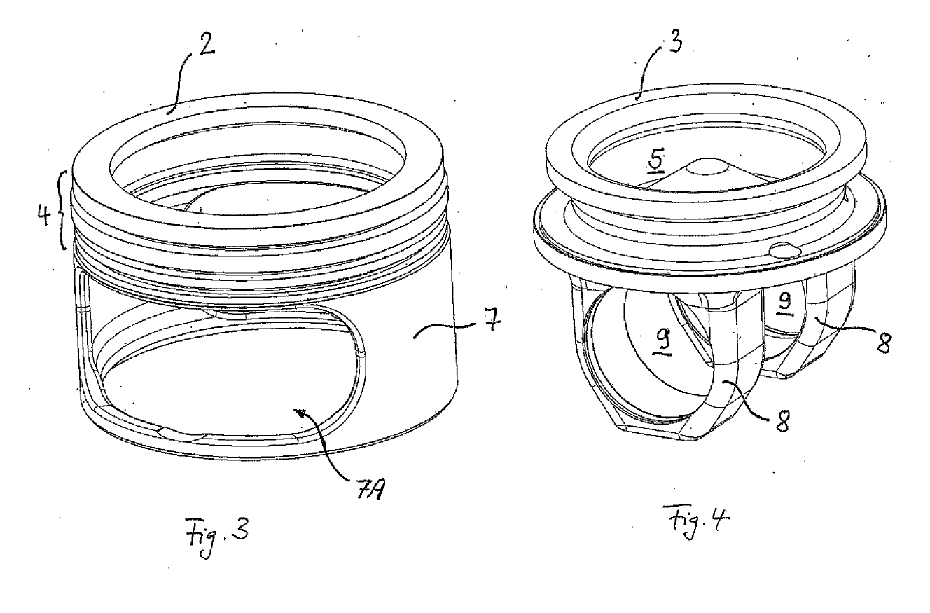

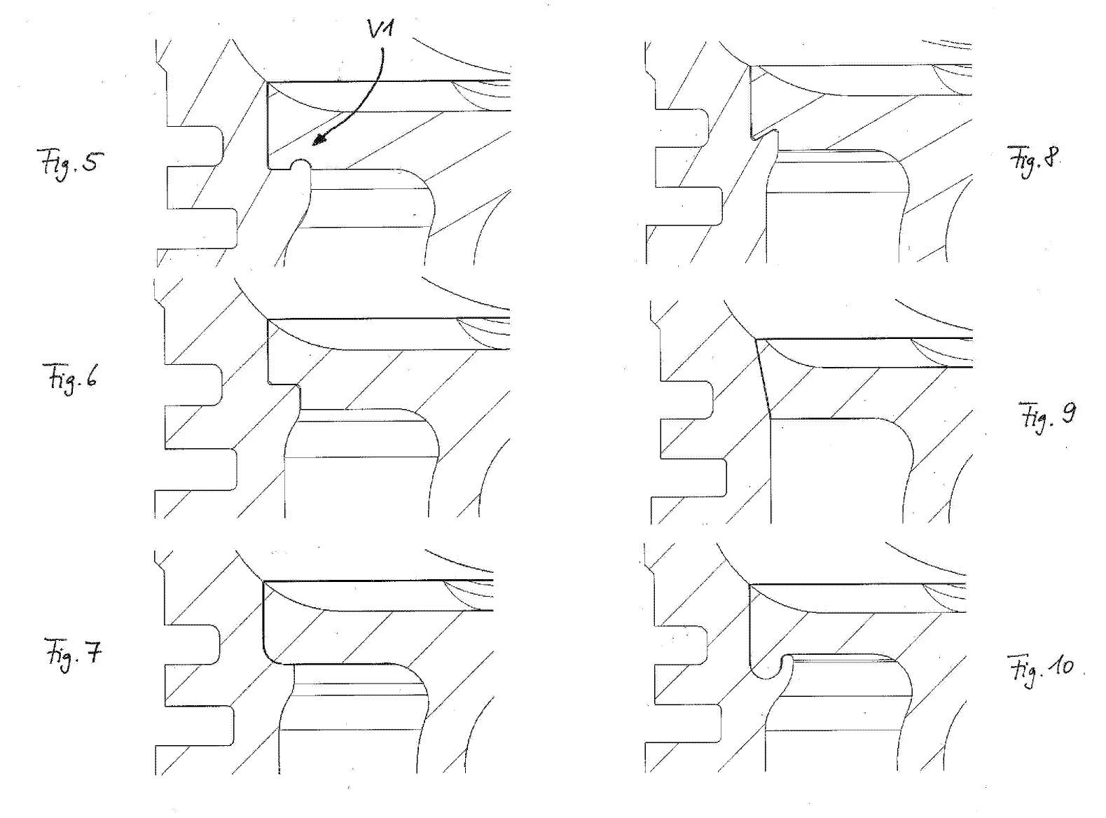

FIGS. 5 to 10 show various illustrative geometries in the region of the joint V1 between the two parts 2, 3. In particular, the geometries shown are chosen in such a way that, when the inner part 3 is inserted into the outer part 2, positive engagement arises in the region of the joint V1, and therefore a further joining operation, e.g. welding or brazing or the like, is required. The materially integral connection of the two parts 2, 3 then takes place only in the region of the joint V1 and/or V2, where the non-detachable connection is accomplished by means of brazing, welding, adhesive bonding or the like. Conversely, it is likewise conceivable for the joint V1 and/or V2 to be configured geometrically in such a way that no positive engagement but only materially integral connection by means of brazing, welding, adhesive bonding or the like is possible.

Depending on the embodiment of the geometries of the two parts 2, 3 in the region of the at least one joint, in particular in the region of both joints, in particular in the region of both joints V1, V2, identical joining methods, e.g. the abovementioned welding, brazing or adhesive bonding, but also shrink-fitting or the like, may be considered. However, this is not absolutely necessary, and therefore different non-detachable joining methods are also possible in the region of the at least one, preferably in the region of both, joints V1, V2.

The geometries in the region of joint V1 which are alternately shown in FIGS. 5 to 10 have the advantage that the outer part 2 can be supported on the inner part 3 and vice versa during the upward and downward movement of the piston 1 along the piston stroke axis 10.

Overall, the novel configuration of a piston of this kind results in a reduction in the use of material, and therefore the weight of the blank can be reduced. Moreover, more economical production as compared with known pistons can be achieved, wherein, by virtue of the shaping of the two parts 2, 3, all regions of the blank parts which initially form the two parts 2, 3 are readily accessible for corresponding machining.

It is self-evident that the piston 1 is finish-machined and adjusted to size when the two parts 2, 3 are arranged in position relative to one another and are non-detachably connected. This applies especially to the spacings of joining beads if these are formed and are troublesome.

### LIST OF REFERENCE SIGNS

1. piston

2. outer part

3. inner part

4. ring groove region

5. combustion chamber recess

6. cooling duct

7. piston skirt

8. piston boss

9. pin bore

10. piston stroke axis

11. pin axis

1. A piston for an internal combustion engine, having a ring groove region, a piston skirt and piston bosses for receiving a piston pin, wherein the piston is formed by an outer part and an inner part, which are produced separately from each other and are joined together non-detachably to form the piston, characterized in that the piston is formed by the outer part, which includes the ring groove region and the piston skirt and into which is inserted the inner part, which includes the piston bosses which respectively define pin bores, wherein the inner part and the outer part are joined together non-detachably in at least one vertical plane.

2. The piston of claim 1 wherein the inner part and the outer part each include two ends, characterized in that the two ends of the inner part and the outer part forming the piston respectively extend from an upper end of the piston, which faces a combustion chamber, to a lower end thereof, which faces a crankcase.

3. The piston of claim 1, characterized in that the piston further comprises a cooling duct, wherein the cooling duct is formed by the inner part.

4. The piston of claim 1, characterized in that the piston further comprises a cooling duct, wherein the cooling duct is formed by the outer part.

5. The piston of claim 1, characterized in that the piston further comprises a cooling duct, wherein the cooling duct is formed by the inner part and by the outer part.

6. The piston of claim 1 further comprising at least one joint region including the at least one vertical plane, wherein on insertion of the inner part into the outer part, the inner part is operable to positively engage the outer part in the joint region.

7. A method for producing a piston of an internal combustion engine, having a ring groove region, a piston skirt and a piston bosses for receiving a piston pin, wherein the piston is formed by an inner part and an outer part, which are produced separately from each other and are joined together non-detachably to form the piston, characterized in that the piston is formed by the outer part, which includes the ring groove region and the piston skirt and into which is inserted the inner part, which includes the piston bosses which respectively define pin bores; and non-detachably joining together the inner part and the outer part in at least one vertical plane.

8. The method of claim 7 wherein joining together the inner part and the outer part further comprises non-detachably welding the inner part and the outer part together in a joint region including the at least one vertical plane.

9. The method of claim 7 wherein joining together the inner part and the outer part comprises non-detachably positively engaging the inner part to the outer part in a joint region including the at least one vertical plane.

10. The piston of claim 2 wherein the inner part further comprises a cooling duct.

11. The piston of claim 2 wherein the outer part further comprises a cooling duct.

12. The piston of claim 2 further comprising a cooling duct defined by the inner part and the outer part.

13. The piston of claim 5 further comprising at least one joint region including the at least one vertical plane, wherein on insertion of the inner part into the outer part, the inner part is operable to positively engage the outer part in the joint region.

14. A piston for use in an internal combustion engine comprising:
an outer part having a ring groove region, and a piston skirt;
an inner part having piston bosses respectively defining piston bores; and
a piston joint region including a first joint comprising a first vertical surface on the inner part and a first vertical surface on the outer part, the inner part operable to be inserted into the outer part whereby the inner part first vertical surface is positioned in proximate opposing and parallel orientation to the outer part first vertical surface, the inner part operable to be non-detachably connected to the outer part in the piston joint region.

15. The piston of claim 14 wherein the inner part and the outer part are non-detachably connected to one another at the inner part first vertical surface and the outer part first vertical surface.

16. The piston of claim 15 wherein the outer part is substantially cylindrical, the outer part piston skirt further defines opposing through bores circumferentially and axially aligned with the inner part pin bores when the inner part is inserted into the outer part.

17. The piston of claim 15 wherein the inner part and the outer part define a cooling duct positioned radially inward from the ring region relative to a piston stroke axis when the inner part is inserted into and connected to the outer part.

18. The piston of claim 17 wherein the piston joint region further comprises a second joint comprising a second vertical surface on the inner part and a second vertical surface on the outer part, the inner part operable to be inserted into the outer part whereby the inner part second vertical surface is positioned in proximate opposing and parallel orientation to the outer part second vertical surface

19. The piston of claim 14 wherein,
the outer part further comprises a positive engagement geometry in the piston joint region; and
the inner part further comprises a positive engagement geometry corresponding to the outer part positive engagement geometry in the piston joint region, the respective corresponding inner part and outer part positive geometries operable to engagingly connect the inner part to the outer part in the piston joint region on insertion of the inner part into the outer part.

20. The piston of claim 19 wherein the outer part positive engagement geometry and the inner part corresponding positive engagement geometry continuously extend circumferentially around a piston stroke axis.
